(19) United States
(12) Patent Application Publication
(10) Pub. No.: US 2015/0328781 A1
(43) Pub. Date: Nov. 19, 2015

(54) KITCHEN KNIFE DEVICE

(71) Applicant: EVERGOOD HARDWARE PRODUCTS CO., LTD., Nantou City (TW)

(72) Inventor: CHEN-FEN CHEN, Nantou City (TW)

(73) Assignee: EVERGOOD HARDWARE PRODUCTS CO., LTD., Nantou City (TW)

(21) Appl. No.: 14/280,334

(22) Filed: May 16, 2014

(51) Int. Cl. B26B 3/03; B26B 9/00

(52) U.S. Cl. CPC B26B 3/03; B26B 9/00

(57) ABSTRACT

A kitchen knife device designed to cut food includes a handle and a blade connected to an end of the handle. The blade has two opposite lateral surfaces, on each of which a plurality of recesses is formed and arranged side-by-side in a row. The recesses formed on the two lateral surfaces of the blade are symmetrical in position. Due to air existing in the recesses, food being cut with the kitchen knife device does not easily stick to the lateral surfaces of the blade, and a user needs not to take time to separate the split food from the lateral surfaces of the blade, making the cutting more efficiently.

### FIELD OF THE INVENTION

The present invention relates to a knife device, and more particularly to a kitchen knife device for cutting various foods.

### BACKGROUND OF THE INVENTION

Kitchen knives, such as cook's knives and fruit knives, are prerequisite kitchen utensils in general families for cutting different foods, such as meat, vegetables, fruits and the like, into small pieces that are easy to cook and bite.

Conventionally, a kitchen knife has a blade with two smooth lateral surfaces. A soft, tender and sticky food, such as fresh meat, when being cut with the conventional kitchen knife, tends to stick to the smooth lateral surfaces of the blade, and the knife user has to separate the sticky food from the blade with one hand after each cutting, so as to proceed with the next cutting or a subsequent preparation. Therefore, the cutting is done in an inefficient manner.

To overcome the above problem, there is developed a kitchen knife having through holes formed on the blade. Air can flow through the through holes to prevent the cut surfaces of the split food from sticking to the lateral surfaces of the blade to ensure good cutting efficiency. However, to avoid lowered blade structural strength, the through holes on the blade usually have a small size and are spaced from one another by a relatively large distance. As a result, the lateral surfaces of the blade still have a large part being the smooth surfaces. That is, there is still a high probability that the soft, tender and sticky food being cut would stick to the lateral surfaces of the blade. Further, no matter the edge of the blade is cut into the food vertically (i.e. in an up-to-down direction) or horizontally (i.e. in a left-to-right or right-to-left direction), the contact areas between the cut surfaces of the food and the two lateral surfaces of the blade gradually increase with the increased cutting depth, so does the resistance of the food to the blade. As a result, the user has to laboriously drive the blade into the food and then laboriously pull the blade out of the food in order to continue the cutting of food. That is, the conventional kitchen knife with through holes formed on the blade still requires a considerable effort to handle it. Another problem is that food fragments or food cut into small pieces tend to become jammed in the through holes on the blade, and it takes time to remove the jammed food fragments from the through holes to cause inconvenience in cleaning the knife.

### SUMMARY OF THE INVENTION

To eliminate the drawbacks of the conventional kitchen knife, it is a primary object of the present invention to provide an improved kitchen knife device that has a plurality of recesses formed on two lateral surfaces of a blade thereof to prevent food being cut from sticking to the surfaces of the blade, so that a user needs not to take time to separate the split food from the blade, making the cutting more efficiently.

To achieve the above and other objects, the kitchen knife device according to the present invention includes a handle and a blade connected to an end of the handle.

The blade has two opposite lateral surfaces, on each of which a plurality of recesses is formed and arranged side-by-side in a row. Further, the recesses arranged on the two lateral surfaces of the blade are symmetrical in position.

According to an embodiment of the present invention, the recesses are respectively elongate in shape, and are extended from near a back of the blade toward an edge of the blade.

According to an embodiment of the present invention, the recesses respectively have a cross section, which is a curved surface.

According to an embodiment of the present invention, the recesses formed on the lateral surfaces of the blade are equally space from one another.

According to an embodiment of the present invention, the recesses are formed on the blade at positions close to the edge of the blade.

With the recesses symmetrically formed on the two lateral surfaces of the blade and arranged side-by-side and equally spaced, air can exist in the recesses. Therefore, gaps are formed between the cut surfaces of two split food sections and the lateral surfaces of the blade when the blade cuts into the food, preventing the split food sections from fully sticking to the bottoms of the recesses. The user needs not to take time to separate the split food sections from the lateral surfaces of the blade, making the cutting more efficiently. Moreover, with the above arrangement, the contact areas between the food being cut and the lateral surfaces of the blade as well as the resistance of the food to the blade during the cutting do not increase in direct proportion to the cutting depth, allowing the user to cut the food effortlessly and efficiently.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a kitchen knife device according to a preferred embodiment of the present invention;

FIG. 2 is a sectional view taken along line A-A of FIG. 1;

FIG. 3 is a sectional view taken along line B-B of FIG. 1; and

FIG. 4 illustrates the use of the kitchen knife device of the present invention to cut food.

### DETAILED DESCRIPTION OF THE PREFERRED EMBODIMENTS

The present invention will now be described with a preferred embodiment thereof and with reference to the accompanying drawings.

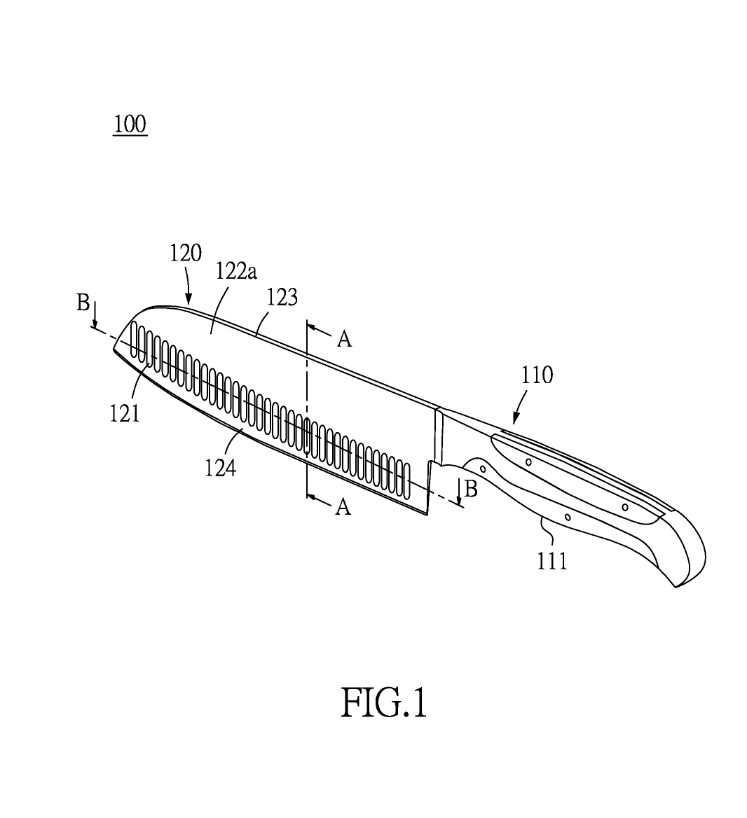

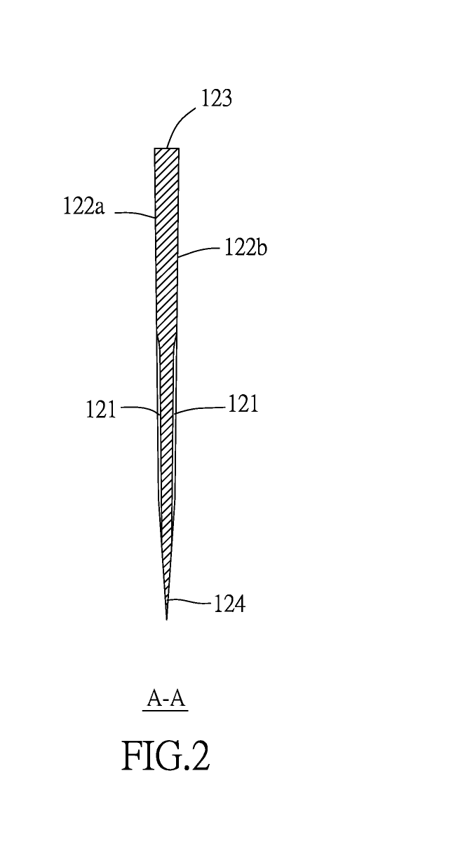

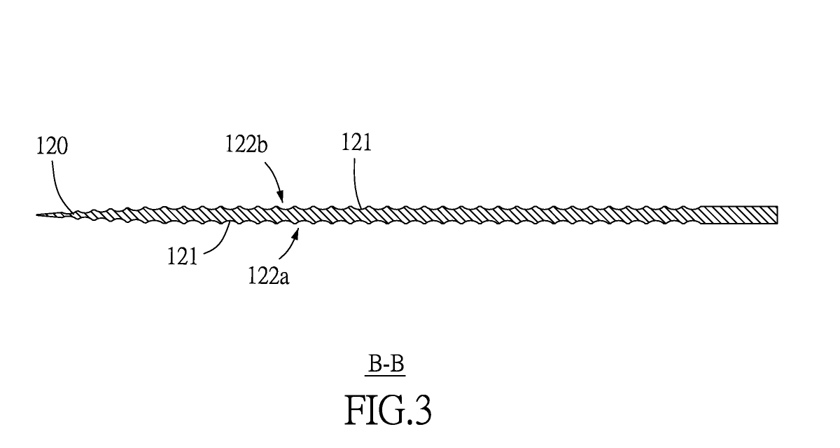

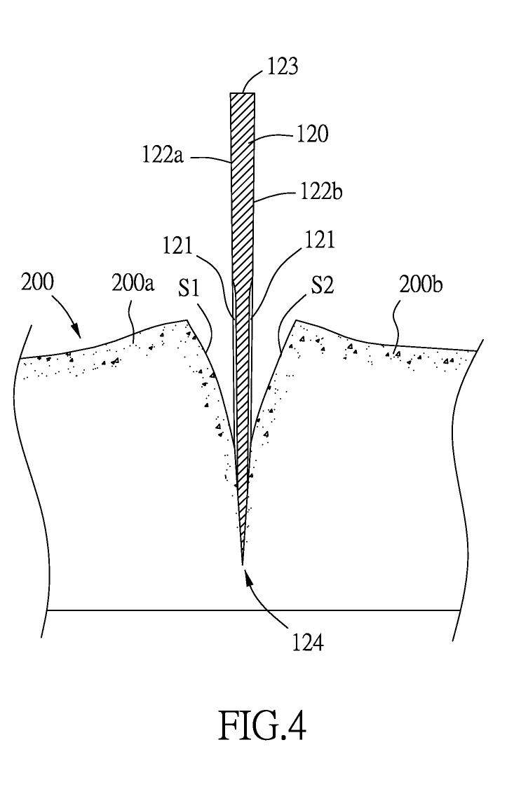

FIG. 1 is a perspective view of a kitchen knife device 100 according to a preferred embodiment of the present invention; FIG. 2 is a sectional view taken along line A-A of FIG. 1; FIG. 3 is a sectional view taken along line B-B of FIG. 1; and FIG. 4 illustrates the use of the kitchen knife device 100 of the present invention to cut food 200. Please refer to FIGS. 1 to 4 at the same time.

As shown, the kitchen knife device 100 includes a handle 110 and a blade 120 connected to an end of the handle 110. The blade 120 has two opposite lateral surfaces 122a, 122b, on each of which a plurality of recesses 121 are formed and arranged side-by-side in a row. The recesses 121 are considerably closely arranged. That is, the recesses 121 are spaced from one another at a very small distance. Further, as can be seen in FIG. 3, the recesses 121 are symmetrically arranged on the two lateral surfaces 122a, 122b of the blade 120.

In the illustrated preferred embodiment, the handle 110 has a lower side formed into a convex surface 111, which meets the principle of ergonomics and allows a user to more easily grip the handle 110 with the user's palm and fives fingers. In an operable embodiment, the handle 110 and the blade 120 are detachably assembled to each other. Or, in another operable embodiment, the handle 110 and the blade 120 are integrally formed.

FIG. 4 illustrates an example of using the kitchen knife device 100 of the present invention to cut food 200 in a vertical direction, i.e. in an up-to-down direction relative to the food 200. The food 200 can be meat, vegetable or the like. To cut the food 200 in the vertical direction, an edge 124 of the blade 120 is first in contact with a top surface of the food 200 and then forced down into the food 200 to split the latter into two sections, namely, a left food section 200a and a right food section 200b as viewed in front of FIG. 4. When the edge 124 of the blade 120 keeps cutting into the food 200 to form the left food section 200a and the right food section 200b, these two food sections 200a, 200b respectively have a left cut surface S1 and a right cut surface S2 that are in sliding contact with the two lateral surfaces 122a, 122b of the blade 120, respectively. With the downward cutting of the blade 120, the left and the right cut surface S1, S2 gradually move into areas of the blade 120 having the recesses 121 formed thereon.

Since the recesses 121 respectively have a certain depth and accordingly have air existing therein, gaps are formed between the left cut surface S1 of the left food section 200a and the left lateral surface 122a of the blade 120, as well as between the right cut surface S2 of the right food section 200b and the right lateral surface 122b of the blade 120, preventing the left and right cut surfaces S1, S2 of the split left and right food sections 200a, 200b from fully sticking to the bottoms of the recesses 121. When the edge 124 of the blade 120 keeps cutting downward, the contact areas between the left cut surface S1 of the left food section 200a and the left lateral surface 122a of the blade 120 as well as between the right cut surface S2 of the right food section 200b and the right lateral surface 122b of the blade 120 are generally limited to two opposite sides of the edge 124 and the small surfaces between any two adjacent recesses 121. That is, the contact areas between the split food 200 and the blade 120 do not increase in direct proportion to the cutting depth of the blade 120. Moreover, due to the relative movement between the blade 10 and the food 200 being cut, the air existing in the recesses 121 provides pressure to push the left and the right food section 200a, 200b away from the left and the right lateral surface 122a, 122b of the blade 120, respectively. Meanwhile, as a result of gravity, the split left and right food sections 200a, 200b naturally tilt down outwardly without sticking to the left and the right lateral surface 122a, 122b of the blade 120. Therefore, it is no need for a user to particularly remove or separate the split food sections 200a, 200b from the blade 120, and the cutting of food 200 can be done more efficiently.

In addition to the fact that the contact areas between the cut surface S1 of the left food section 200a and the left lateral surface 122a of the blade 120 as well as between the right cut surface S2 of the right food section 200b and the right lateral surface 122b of the blade 120 do not increase in direct proportion to the cutting depth of the blade 120, a frictional force between the cut surface S1 of the left food section 200a and the left lateral surface 122a of the blade 120 as well as between the right cut surface S2 of the right food section 200b and the right lateral surface 122b of the blade 120 do not increase in direct proportion to the cutting depth of the blade 120, either. In other words, a resistance of the cut food 200 to the downward cutting blade 120 does not increase with the increasing cutting depth of the blade 120. Thus, the kitchen knife device 100 of the present invention has the advantages of being operable in a labor-saving manner and enabling high cutting efficiency.

While the above description with reference to FIG. 4 illustrates the use of the kitchen knife device 100 to cut the food 200, such as meat or vegetable, in a vertical or up-to-down direction, it is understood the kitchen knife device 100 of the present invention can also be used to cut the food 200 in a horizontal direction, including a left-to-right and a right-to-left direction.

Therefore, with the recesses 121 formed on the two lateral surfaces 122a, 122b of the blade 120, no matter the edge 124 of the blade 120 of the kitchen knife device 100 is vertically or horizontally directed to the food 200 to be cut, neither the contact areas between the cut surfaces S1, S2 of the food 200 at the cut-open area with the lateral surfaces 122a, 122b of the blade 120 nor the resistance of the food 200 to the blade 120 increase in direct proportion to the cutting depth of the blade 120. Thus, with the blade 120 provided with the recesses 121, a user can effortlessly drive the blade 120 into the food 200 and effortlessly lift the kitchen knife device 100 from the food 200 to proceed with a next cutting movement.

In the illustrated preferred embodiment, the recesses 121 are respectively elongate in shape and have a longitudinal axis extended from near a back 123 of the blade 120 toward the edge 124. Preferably, the elongate recesses 121 are extended in a direction parallel to the cutting direction of the blade 120, so that the kitchen knife device 100 can be cut into the food 200 in an even smoother manner.

Further, as can be most clearly seen in FIG. 4, each of the recesses 121 has a cross section, which is a curved surface, and preferably a curved surface without inflection point. That is, the recesses 121 are respectively a shallow recess having a bottom formed into a curved surface. With this configuration, dirt or fragments of food 200 would not easily become trapped in the recesses 121, and the kitchen knife device 100 can be easily washed clean. Further, the recesses 121 are equally spaced on the lateral surfaces 122a, 122b of the blade 120 and are arranged side-by-side in a horizontal row on each of the lateral surfaces 122a, 122b at a position closer to the edge 124. With this arrangement, the recesses 121 function to automatically separate the left and right food sections 200a, 200b from the lateral surfaces 122a, 122b as soon as the food 200 is cut open by the edge 124 of the blade 120. According to the present invention, the depth of every recess 121 and the array of the recesses 121 on the lateral surfaces 122a, 122b of the blade 120 can be determined according to the size of the blade 120.

Preferably, the recesses 121 are formed on the left and right lateral surfaces 122a, 122b of the blade 120 by using a grinding machine. That is, the recesses 121 can be formed by driving one or more abrasive wheels of a grinding machine to grind the two lateral surfaces 122a, 122b of the blade 120 and thereby form recesses 121 with predetermined depth and length. Compared to other types of machining equipment, such as a stamping machine, the grinding machine has the advantages of easy to manufacture, low cost, and occupying only a relatively small space.

In conclusion, the kitchen knife device according to the present invention is characterized in a blade having a plurality of recesses symmetrically formed on two lateral surfaces thereof. The recesses on each of the two lateral surfaces of the blade are closely arranged side-by-side in a row and equally spaced at intervals of a relatively small distance. Further, the recesses are elongate in shape and respectively have a predetermined depth with air exists therein. Therefore, when using the blade to cuts the food, gaps are formed between the cut surfaces of two food sections and the lateral surfaces of the blade, preventing the cut surfaces of the split food sections from fully sticking to the bottoms of the recesses. The user needs not to take time to separate the split food sections from the lateral surfaces of the blade, making the cutting more efficiently. Moreover, with the above arrangement, the contact areas between the food being cut and the lateral surfaces of the blade as well as the resistance of the food to the blade during the cutting do not increase in direct proportion to the cutting depth, allowing the user to cut the food effortlessly and efficiently.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A kitchen knife device, comprising:
a handle; and
a blade being connected to an end of the handle; the blade having two opposite lateral surfaces, on each of which a plurality of recesses is formed and arranged side-by-side in a row; and the recesses formed on the two lateral surfaces of the blade being symmetrical in position.

2. The kitchen knife device as claimed in claim 1, wherein the recesses are respectively elongate in shape, and the elongate recesses being respectively extended from near a back of the blade toward an edge of the blade.

3. The kitchen knife device as claimed in claim 2, wherein the recesses respectively have a cross section that is a curved surface.

4. The kitchen knife device as claimed in claim 3, wherein the recesses formed on each of the lateral surfaces of the blade are equally spaced from one another.

5. The kitchen knife device as claimed in claim 1, wherein the recesses are formed on the blade at positions close to an edge of the blade.

6. The kitchen knife device as claimed in claim 2, wherein the recesses are formed on the blade at positions close to an edge of the blade.

7. The kitchen knife device as claimed in claim 3, wherein the recesses are formed on the blade at positions close to an edge of the blade.

8. The kitchen knife device as claimed in claim 4, wherein the recesses are formed on the blade at positions close to an edge of the blade.
